(19) United States
(12) Patent Application Publication
(10) Pub. No.: US 2026/0218872 A1
(43) Pub. Date: Jul. 30, 2026

(54) LIGHTING MODULE FOR A MOTOR VEHICLE COMPRISING ARTICULATED CONNECTION ELEMENTS

(71) Applicant: VALEO VISION, Bobigny (FR)

(72) Inventors: Nicolas MARTIN, Bobigny (FR); Sylvain GIRAUD, Bobigny (FR)

(73) Assignee: VALEO VISION, Bobigny (FR)

(21) Appl. No.: 19/140,198

(22) PCT Filed: Dec. 20, 2023
(86) PCT No.: PCT/EP2023/086848

§ 371 Date: Jun. 17, 2025

(30) Foreign Application Priority Data
Dec. 21, 2022 (FR) 2214188

(51) Int. Cl. F21S 41/25; F21S 41/19; F21S 41/29

(52) U.S. Cl. CPC F21S 41/25; F21S 41/19; F21S 41/295

(57) ABSTRACT

The invention relates to a lighting module for a vehicle. The lighting module includes a lighting unit with at least one light source configured to emit light rays, at least one collector associated with the light source, a projection optical element having an optical axis, the collector orienting the light rays towards the projection optical element, and the projection optical element projecting the light rays towards the outside of the vehicle so as to form a light beam, a holder on which the projection optical element is fixedly mounted. The lighting module also includes two connection elements that are each connected to the lighting unit and to the holder, and articulated so as to allow a first movement of the lighting unit relative to the projection optical element, making it possible to move the light beam in a first direction orthogonal to the optical axis of the projection optical element.

### TECHNICAL FIELD

The present invention relates to a luminous module for an automotive vehicle. It relates in particular to a luminous module making it possible to form a light beam and making it possible to move this light beam in a first direction, and possibly in a second direction.

### BACKGROUND OF THE INVENTION

In the field of automotive vehicles, a luminous module for a vehicle that is well known to a person skilled in the art comprises:
a luminous unit comprising at least one light source configured to emit light rays, and at least one collector associated with said at least one light source,
an optical projection element, the collector being configured to collect and direct said light rays emitted by said at least one light source toward the optical projection element, said optical projection element being configured to project said light rays toward the outside of said vehicle to form a light beam.

The luminous module is intended to be integrated in a luminous device such as an automotive vehicle headlamp. The luminous device generally comprises one or more masks which are positioned close to the luminous module, in particular for example around the optical projection element. These masks are styling components that allow certain parts of the luminous module, such as the collector, to be shielded from an external observer.

In order to be able to adapt the light beam formed by the luminous module to the automotive vehicle on which the luminous device comprising the luminous module is mounted, and to the traffic conditions, it is possible to move the luminous module in such a way as to allow horizontal and/or vertical movement of the light beam. Vertical movement of the light beam is particularly useful in order to factor in vehicle body defects linked to manufacturing tolerances, or to factor in the attitude of the vehicle, which varies from one category of vehicle to another and which varies according to the vehicle load. The light beam may for example be lowered to avoid dazzling an occupant of an oncoming vehicle. Horizontal movement of the light beam is useful for adjusting the position of the light beam formed by the luminous module relative to the median longitudinal axis of the vehicle, for example to compensate for body defects. Horizontal movement of the light beam is also useful when two luminous modules are arranged in the luminous device. To be specific, it is then necessary to adjust the two luminous modules relative to one another, to ensure good alignment of the light beam formed by each of the luminous modules relative to one another and relative to the median longitudinal axis of the vehicle.

When the luminous module is moved to adjust the light beam, all of the parts of which it is composed are set in motion, namely in particular said at least one light source, said at least one collector and said at least one optical projection element.

The mask(s) arranged closed to the luminous module are, on the contrary, stationary when the luminous module is moved. It is therefore necessary to provide sufficient clearance between the mask(s) and the luminous module so that the luminous module does not come up against the mask(s) when it is moved.

### SUMMARY OF THE INVENTION

In this context, the present invention aims to propose a luminous module for an automotive vehicle that proposes a solution to the abovementioned disadvantage. In particular, the invention proposes a luminous module for an automotive vehicle which makes it possible to move the light beam that it forms, while minimizing the clearances necessary between the luminous module and the masks arranged close to the luminous module, and in particular close to the optical projection element.

To this end, the invention proposes a luminous module for an automotive vehicle, said luminous module comprising:
a luminous unit comprising at least one light source configured to emit light rays and at least one collector associated with said at least one light source,
an optical projection element having an optical axis, said collector being configured to collect and direct said light rays emitted by said at least one light source toward the optical projection element, said optical projection element being configured to project said light rays toward the outside of said vehicle to form a light beam,
a support on which the optical projection element is fixedly mounted;
two connection elements each connected on the one hand to the luminous unit and on the other hand to the support, each connection element being configured and articulated in such a way as to allow a first movement of the luminous unit relative to the optical projection element, said first movement allowing the light beam to be moved in a first direction orthogonal to the optical axis of the optical projection element.

Thus, by moving the luminous unit relative to the optical projection element, the light beam can be moved. Once the luminous module is mounted on a vehicle, it is therefore possible to adjust the position of the light beam so that it is adapted to the vehicle.

Furthermore, since the optical projection element is fixedly mounted on the support of the module and since the luminous unit and the connection elements are movable relative to the optical projection element, this means that the luminous unit and the connection elements are arranged movably relative to said support. It is possible to move the luminous unit without moving the optical projection element thanks to the articulation of the connection elements. This articulation of the connection elements makes it possible to move only the luminous unit relative to the support, while the optical projection element remains fixed on the support, or in other words, it remains stationary relative to the support during the first movement.

Thus, by moving the luminous unit, the light beam can be moved without the optical projection element being moved. The luminous module therefore makes it possible to move the light beam that it forms, without moving the optical projection element. Therefore, it is possible to arrange a mask in the immediate vicinity of the optical projection element. To be specific, as the optical projection element is stationary while the light beam is being adjusted, the optical projection element will not come up against the mask during this adjustment.

Note that, in the context of the invention, the term “first” can be understood to mean “first and only” or to mean that there may be at least one “second” element. Thus, the luminous unit may be moved according to a first movement only or, as will be seen below, according to a first and a second movement. Likewise, the light beam may be moved in a first and only orthogonal direction or, as will be seen below, in a first and a second orthogonal direction.

The first direction orthogonal to the optical axis may for example be a vertical direction or transverse direction, defined when the luminous module is mounted on the automotive vehicle.

The first movement of the luminous unit relative to the projection element may be a translation of the luminous unit relative to the projection element. Note that this translation may be a rectilinear or circular translation.

According to one feature of the invention, the connection elements are arranged on either side of the optical projection element and/or on either side of said at least one collector.

According to one feature of the invention, each connection element comprises a central portion, a front portion and a rear portion, the central portion and the rear portion being articulated by a rear pivot connection with an axis orthogonal to the optical axis and to the first orthogonal direction, and the central portion and the front portion being articulated by a front pivot connection with an axis orthogonal to the optical axis and to the first orthogonal direction.

The front pivot connections connecting the front and central portions of each connection element and the rear pivot connections connecting the rear and central portions of each connection element allow the connection elements to be articulated. In particular, during its first movement, the luminous unit may be moved in a circular translation by virtue of the front and rear pivot connections, relative to the optical projection element. However, given the dimensions of the luminous module, and in particular the length of the central portions of the connection elements, this circular translation may be likened to a translation in the first orthogonal direction.

According to one feature of the invention, the optical projection element is arranged in front of the front pivot connections and the luminous unit is attached to the rear portions.

According to one feature of the invention, the front and rear pivot connections define the vertices of a parallelogram, in projection in a plane defined by the optical axis and the first orthogonal direction.

According to one alternative, the pivot connections are flexible connections with semicircular necks. The front, central and rear portions of each connection element may then be formed integrally. The production of the connection elements in a single piece makes it possible to simplify the assembly of the luminous module and reduce its overall bulk.

According to another alternative, the front, central and rear portions are formed by three separate parts. According to one example, the central portion may comprise at least a front cylindrical pin and a rear cylindrical pin with an axis orthogonal to the optical axis and to the first orthogonal direction, and the front portion may comprise a hole in which the front cylindrical pin is engaged in such a way as to form the front pivot connection, and the rear portion may comprise a hole in which the rear cylindrical pin is engaged in such a way as to form the rear pivot connection. In particular, the rear portion of each connection element may be formed by a part of the luminous unit, such as for example the collector. The production of the connection elements in three separate parts makes it possible to facilitate manufacture of the connection elements.

According to one alternative, the front portion of each connection element is mounted fixedly on the support. According to this alternative, the optical projection element may be fixed to the front portions of the connection elements. Each connection element is then connected to the optical projection element.

In particular, the luminous module may comprise at least one crossbar joining the front portions of each of the connection elements, the front portions and said at least one crossbar forming a support for the optical projection element.

According to another alternative, the front portion of each connection element is mounted movably relative to the support.

According to one feature of the invention, each connection element is configured and articulated in such a way as to allow a second movement of the luminous unit relative to the optical projection element, said second movement allowing the light beam to be moved in a second direction orthogonal to the optical axis of the optical projection element, and orthogonal to the first orthogonal direction.

The second direction orthogonal to the optical axis may for example be a vertical direction, in the case where the first direction is a transverse direction or may be a transverse direction, in the case where the first direction is a vertical direction, the transverse and vertical directions being defined when the luminous module is mounted on the automotive vehicle.

Thus, the light beam may be moved in a second direction, by moving the luminous unit relative to the optical projection element, the optical projection element always being stationary relative to the support.

According to one feature of the invention, the front portion of each connection element is connected to the support by an additional articulation allowing the rotation of the luminous unit and the connection elements about an axis of rotation located in front of the front pivot connections and oriented in the first orthogonal direction.

For example, each front portion is articulated to the support by a pivot connection with an axis parallel to the first orthogonal direction.

Thus, the luminous module comprises the front and rear pivot connections to allow the first movement of the luminous unit, and the pivot connection formed by the front portions to allow the second movement of the luminous unit, which allows the first movement and the second movement to be adjusted independently. The use of these pivot connections thus makes it possible to obtain a luminous module which is less bulky than a module using ball joints.

According to one feature of the invention, the luminous module comprises a crossbar extending between the front portions of each connection element. This crossbar makes it possible to stiffen the connection elements.

According to one feature of the invention, the optical projection element comprises a median transverse axis arranged at a distance of less than 30 mm, preferably less than 15 mm, and even more preferably less than 5 mm from the axis of rotation. Alternatively, the median transverse axis coincides with the axis of rotation. Thus, during the second movement of the luminous unit, the distance between said at least one light source and the median transverse axis of the optical projection element changes little, or even remains constant, which limits the deformation of the light beam formed.

According to one feature of the invention, the first movement of the luminous unit is intended to be activated by a primary actuator, said luminous unit being configured to be connected to the primary actuator by an annular linear connection with an axis perpendicular to the first orthogonal direction and to the optical axis. Thus, even when the luminous unit is moved according to the second movement, the primary actuator can still allow the luminous unit to be moved according to the first movement.

Alternatively, the first movement of the luminous unit is intended to be activated by a primary actuator, said luminous unit being configured to be connected to the primary actuator by an annular linear connection with the optical axis.

According to one feature of the invention, the second movement of the luminous unit is intended to be activated by a secondary actuator, said luminous unit being configured to be connected to the secondary actuator by an annular linear connection with an axis parallel to the first orthogonal direction. Thus, even when the luminous unit is moved according to the first movement, the secondary actuator can still allow the luminous unit to be moved according to the second movement.

According to one feature of the invention, each collector comprises a reflective surface. Where applicable, the optical projection element may be configured to mirror the reflective surface of each collector.

For example, the optical projection element comprises one or more object focal points, the rear edge of each collector of the luminous unit being arranged close to the object focal point or one of the object focal points of the optical projection element.

According to one feature of the invention, the optical projection element is a projection lens. The optical projection element then has a single object focal point, which can take the form of an object focal line. In this case, the optical axis of the optical projection element corresponds to the optical axis of the projection lens. Alternatively, the optical projection element is formed by a juxtaposition of projection lenses. Each projection lens forming the optical projection element then has an object focal point. In this case, the optical axis of the optical projection element may then be considered to be an average optical axis of the optical projection element.

Alternatively, the optical projection element may be formed by one or more mirrors or any other combination of lens(es) and mirror(s).

According to one feature of the invention, the luminous unit comprises at least two light sources, at least two collectors, at least one light source being associated with each collector, and at least one additional connection element arranged between the two collectors and between said two connection elements, referred to as lateral connection elements, in the first orthogonal direction, the additional connection element extending longitudinally between the luminous unit and the optical projection element, and being configured and articulated in such a way as to allow the first movement of the luminous unit relative to the optical projection element, or the first and second movement of the luminous unit relative to the optical projection element.

Also proposed is an automotive vehicle luminous device comprising at least one luminous module according to the invention.

According to a non-limiting embodiment, the luminous device is a headlamp.

According to a non-limiting feature, the luminous device comprises a housing having a recess, the luminous module being arranged in said recess.

According to a non-limiting feature, the support of the luminous module is formed by a portion of the housing or a part rigidly secured to the housing.

According to one non-limiting feature, the housing comprises an opening arranged in front of the recess, and the luminous device comprises a closure outer lens closing off the opening of the housing. The luminous module is then located between the housing and the closure outer lens.

Alternatively, the housing comprises an opening arranged in front of the recess, and the optical projection element closes off the opening of the housing. The luminous device then does not include any closure outer lens. The optical projection element plays the role of the closure outer lens. To be specific, since the optical projection element remains fixed when the light beam is moved, it can close off the opening of the housing.

### BRIEF DESCRIPTION OF DRAWINGS

The invention and the various applications thereof will be understood more clearly from reading the following description and studying the accompanying figures:

FIG. 1 is a perspective view of a luminous module according to a first embodiment of the invention, comprising a luminous unit, an optical projection element fixedly mounted on a support and connection elements for connecting the luminous unit to the support,

FIG. 2 is a perspective kinematic diagram of the luminous module of FIG. 1, showing a first movement of the luminous unit relative to the optical projection element,

FIG. 3 is a top and side view of the luminous module of FIG. 1, during the first movement of the luminous unit relative to the optical projection element as shown in FIG. 2,

FIG. 4 is a perspective view of a luminous module according to a second embodiment of the invention, comprising a luminous unit, an optical projection element fixedly mounted on a support and connection elements for connecting the luminous unit to the support,

FIG. 5 is a perspective kinematic diagram of the luminous module of FIG. 4, showing the luminous module in a nominal position,

FIG. 6 is a perspective kinematic diagram of the luminous module of FIG. 4, showing a first movement of the luminous unit relative to the optical projection element,

FIG. 7 is a perspective kinematic diagram of the luminous module of FIG. 4, showing a second movement of the luminous unit relative to the optical projection element,

FIG. 8 is a top and side view of the luminous module of FIG. 4 when in a nominal position as shown in FIG. 5,

FIG. 9 is a top and side view of the luminous module of FIG. 4, during the first movement of the luminous unit relative to the optical projection element, as shown in FIG. 6,

FIG. 10 is a top and side view of the luminous module of FIG. 4, during the second movement of the luminous unit relative to the optical projection element as shown in FIG. 7,

FIG. 11 is a top and side view of the luminous module of FIG. 4 during a first movement and a second movement of the luminous unit relative to the optical projection element,

FIG. 12 shows a top view of an alternative embodiment of the module of FIG. 4, in which the luminous module comprises an additional connection element,

FIG. 13 schematically shows the light rays generated by a light source of the luminous unit and directed by a collector of the luminous unit toward the optical projection element,

FIG. 14 is a perspective view of a luminous module according to a variant of the second embodiment of the invention, comprising a luminous unit comprising a plurality of collectors, an optical projection element fixedly mounted on a support and connection elements for connecting the luminous unit to the support,

FIG. 15 is a perspective view of the luminous module of FIG. 15 with the collectors removed,

FIG. 16 is a schematic top view of a luminous device comprising a housing with an opening, a closure outer lens closing off the opening and a luminous module according to the invention arranged in the housing, and

FIG. 17 is a schematic top view of a luminous device comprising a housing with an opening and a luminous module according to the invention arranged in the housing, the optical projection element closing off the opening of the housing.

### DETAILED DESCRIPTION OF THE INVENTION

Elements that are identical, in terms of structure or function, and that appear in different figures are denoted by the same reference signs, unless specified otherwise.

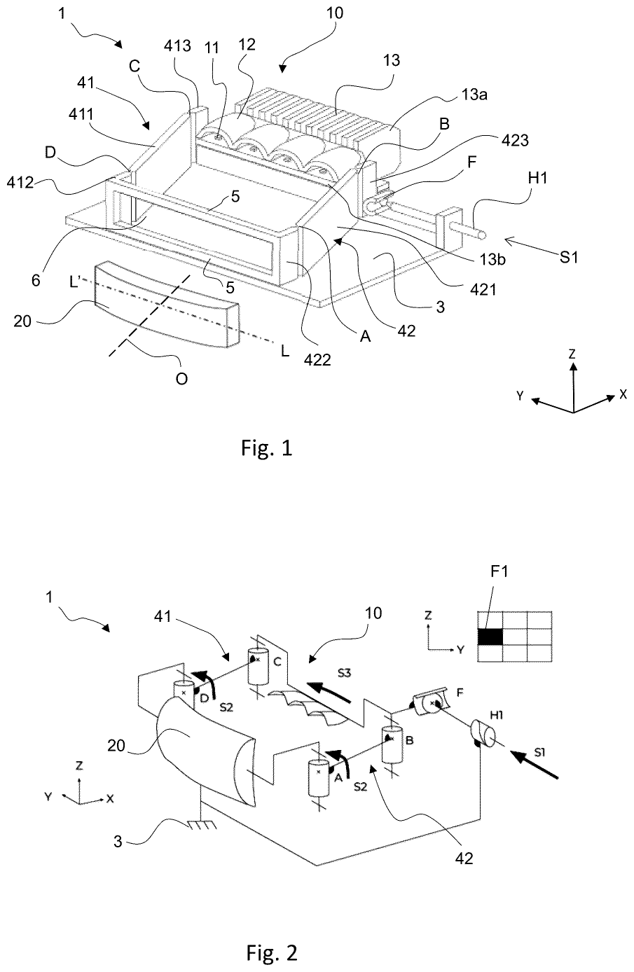

FIGS. 1 to 3 show a luminous module 1 for an automotive vehicle, according to a first embodiment of the invention. The luminous module 1 is intended to be mounted in a luminous device of an automotive vehicle, such as an automotive vehicle headlamp. The luminous device is itself intended to be mounted on an automotive vehicle.

In the remainder of the description, the longitudinal direction X will be understood as being the longitudinal direction of the vehicle in which the luminous module is intended to be mounted, by means of the luminous device, the transverse direction Y, perpendicular to the longitudinal direction X will be understood as being the direction transverse to said vehicle, and the vertical direction Z will be understood as being the direction perpendicular to the longitudinal X and transverse Y directions.

The luminous module 1 comprises a luminous unit 10, an optical projection element 20, a support 3 on which the optical projection element 20 is mounted and two connection elements 41, 42 for connecting the luminous unit 10 to the support 3. In FIG. 1, the optical projection element 20 is shown in front of the support 3 for the sake of clarity, it being understood that the optical projection element 20 is normally positioned on the support 3.

The luminous unit 10 comprises light sources 11 and collectors 12. The light sources 11 are all associated with one of the collectors 12. In the example illustrated, one collector 12 is associated with each light source 11, it being understood that it is also possible for several light sources 11 to be associated with the same collector 12, without departing from the scope of the invention. The light sources 11 are activatable selectively.

The luminous unit 10 also comprises a heat sink 13, making it possible to dissipate the heat produced by the light sources 11. The heat sink 13 comprises a plate 13b extending horizontally, in other words in a plane comprising the longitudinal X and transverse Y directions, and a plurality of fins 13a extending behind the collectors 12. They could also extend below the collectors, or both behind and below the collectors 12. The light sources 11 are arranged on the plate 13b. They may be arranged directly or indirectly. In the case where the light sources 11 are arranged indirectly, the luminous unit 10 may comprise a printed circuit arranged on the plate 13b and on which the light sources 11 are arranged. The collectors 12 are attached to the heat sink 13, in particular to the plate 13b of the heat sink 13. Where applicable, the printed circuit may be sandwiched between the plate 13b and the collectors 12.

Each light source 11 is configured to emit light rays toward the collector 12 with which it is associated. The collector 12 collects and directs the light rays toward the optical projection element 20. In particular, each collector 12 comprises a reflective surface 12a (visible in FIG. 13). The reflective surface 12a of each collector 12 reflects the light rays emitted by the light source(s) 11 with which it is associated, toward the optical projection element 20.

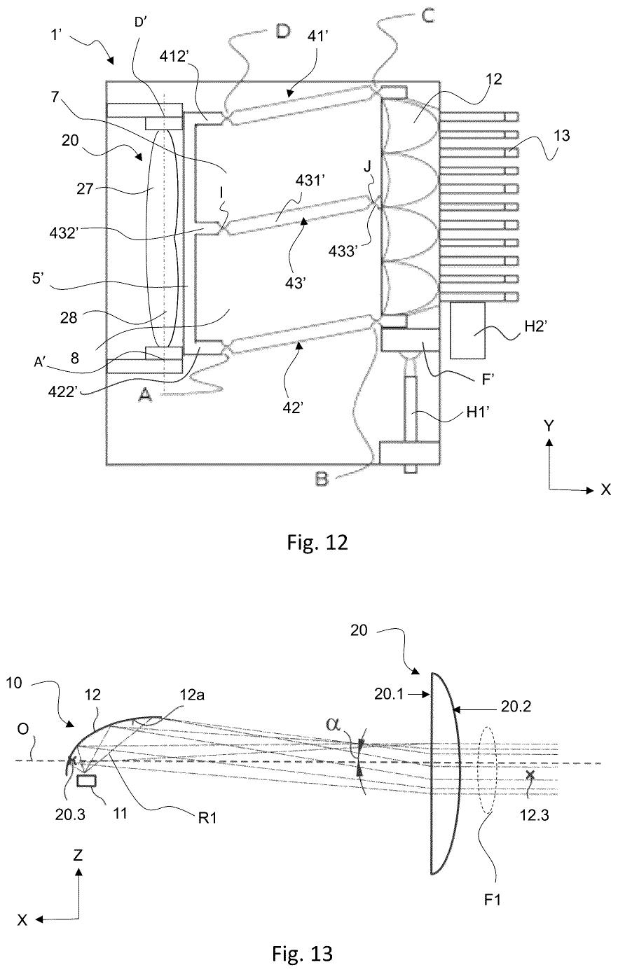

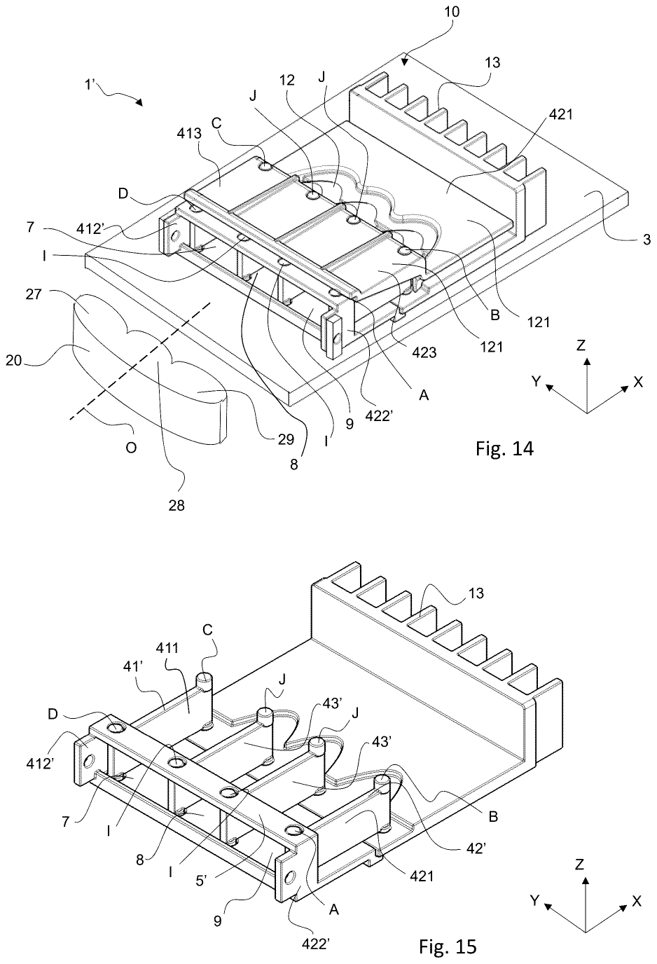

The optical projection element 20 has an optical axis O. In the example illustrated, the optical axis O of the optical projection element 20 is parallel to the longitudinal direction X. The optical projection element 20 is in this case a projection lens. As will be seen below, in particular with reference to FIGS. 12 and 14, the optical projection element 20 may also be formed by a plurality of juxtaposed projection lenses. Alternatively, the optical projection element could be formed by one or more mirrors or any other combination of lens(es) and mirror(s).

The optical projection element 20 receives the light rays reflected by the collectors 12 and projects these reflected rays toward the outside of the luminous module 1, and toward the outside of the automotive vehicle on which the luminous module 1 is intended to be mounted, to form a light beam F1.

The path of the light rays emitted by the light sources 11, reflected by the collectors 12 and projected by the optical projection element 20 is shown in FIG. 13. Each collector 12 has an elliptical or parabolic or free-form shape. The light source(s) 11 associated with the collector 12 are arranged at the first focal point of the collector 12, or close to this first focal point, for example at a distance of less than 10 mm. The light rays R1 emitted by the light source(s) 11 are then collected and reflected by the reflective surface 12a of the collector 12 toward the optical projection element 20. For each collector 12, the optical projection element 20 then projects the collected and reflected rays onto the road and thus forms a light sub-beam. All of the light sub-beams are superimposed to form a light beam F1.

The optical projection element 20 comprises an object focal point 20.3 arranged in the vicinity of a rear edge of at least one of the collectors 12 of the luminous unit 10. Alternatively, the optical projection element 20 may have a focal line passing in the vicinity of a rear edge of each of the collectors 12. “In the vicinity” means at a distance of less than or equal to 10 mm. The optical projection element 20 thus forms an image of the reflective surface 12a of at least one, or of each, collector 12. The light sub-beams formed correspond to this image of the reflective surface 12a.

In particular, the rear edge of at least one collector 12 may have a specific cut-out, the optical projection element 20 thus projects this cut-out in the light sub-beam resulting from the reflection of light rays on this collector 12. For example, the light sub-beam may thus have an upper horizontal cut-off formed by the projection of the cut-out by the optical projection element 20.

The light beam F1 may for example be all or part of a low beam. The light beam F1 may for example be all or part of a high beam. For example, it is possible that some collectors 12 contribute only to the formation of the low beam, while other collectors 12 contribute to the formation of an additional high beam, which in combination with the low beam makes it possible to form the high beam. Thus, the light sources 11 may be selectively switched on or off to form a low beam or a high beam.

The optical projection element 20 is fixedly mounted on the support 3. In other words, the optical projection element 20 is always stationary relative to the support 3.

The optical projection element 20 and the support 3 on the one hand, and the luminous unit 10 on the other hand, are connected together by the connection elements 41, 42. The connection elements 41, 42 are each connected on the one hand to the luminous unit 10 and on the other hand to the support 3.

Each connection element 41, 42 is configured and articulated in such a way as to allow a first movement of the luminous unit 10 relative to the optical projection element 20. The first movement allows the light beam F1 to be moved in a first direction orthogonal to the optical axis O of the optical projection element 20.

In the example shown, the first direction orthogonal to the optical axis O is a transverse direction Y. In a variant that has not been shown, the first orthogonal direction could be a vertical direction Z.

In particular, the connection elements 41, 42 are arranged on either side of the optical projection element 20 and the collectors 12 in the first orthogonal direction.

Each connection element 41, 42 comprises a central portion 411, 421, a front portion 412, 422 and a rear portion 413, 423, the central portion 411, 421 and the rear portion 413, 423 being articulated by a rear pivot connection C, B with an axis orthogonal to the optical axis O and to the first orthogonal direction Y, and the central portion 411, 421 and the front portion 412, 422 being articulated by a front pivot connection A, D with an axis orthogonal to the optical axis O and to the first orthogonal direction Y. Throughout the description, the front and rear directions are considered relative to the direction of emission of light in the luminous module 1, along the optical axis O of the optical projection element 20. The direction of emission is opposite to the direction of the longitudinal axis X shown in the figures.

The luminous unit 10 is attached to the connection elements 41, 42 by the rear portions 413, 423. The rear portions 413, 423 may in particular be formed by an element of the luminous unit 10, such as for example by the heat sink 13 or a collector 12.

The support 3 is attached to the connection elements 41, 42 by the front portions 412, 422.

In the first embodiment, the front portions 412, 422 are fixedly mounted on the support 3. Note that, unlike the front portions 412, 422, the central portions 411, 421 and the rear portions 413, 423 are movable relative to the support 3. The luminous module 1 comprises two crossbars 5 joining the front portions 412, 422 of each of the connection elements 41, 42. The front portions 412, 422 and the crossbars 5 form a support for the optical projection element 20. Thus, the optical projection element 20, which is shown in front of the support 15 for the sake of clarity in FIG. 1, is in fact arranged in the window 6 formed by the front portions 412, 422 and the crossbars 5. The optical projection element 20 is thus fixed to the front portions 412, 422 of the connection elements 41, 42. The optical projection element 20 is thus arranged in front of the front pivot connections A, D.

In the example shown in FIG. 1, the front A, D and rear B, C pivot connections are formed by flexible connections with semicircular necks. As will be seen below, with reference to FIGS. 14 and 15, the front pivot connections A, D may also be formed by at least one cylindrical pin arranged on one out of the central portion 411, 421 and the front portion 412, 422 and a hole interacting with the pin arranged on the other out of the central portion 411, 421 and the front portion 412, 422, and the rear pivot connections B, C may be formed by at least one cylindrical pin arranged on one out of the central portion 411, 421 and the rear portion 413, 423 and a hole arranged on the other out of the central portion 411, 421 and the rear portion 413, 423.

The front A, D and rear B, C pivot connections define the vertices of a parallelogram, in projection in a plane defined by the optical axis O and the first orthogonal direction Y. In other words, the central portions 411, 421 are of the same length and parallel.

The first movement of the luminous unit is activated by a primary actuator H1. The kinematics of the luminous module 1 during the movement of the light beam F1 in the first orthogonal direction Y are shown in FIG. 2. As can be seen in FIG. 2, the luminous unit 10 is connected to the primary actuator H1 by an annular linear connection F with the optical axis O.

In FIG. 2, a movement S1 is exerted on the primary actuator H1, the primary actuator H1 pushes the luminous unit 10, in particular the heat sink 13 on which the collectors 12 and the light sources 11 are arranged. The luminous unit 10 follows the movement induced by the primary actuator H1 and is moved in a circular translation by virtue of the front A, D and rear C, D pivot connections. However, given the dimensions of the luminous module, and in particular the length of the central portions 411, 421 of the connection elements 41, 42, this circular translation may be likened to a translation in the transverse direction Y. This movement is indicated by the arrow S3 in FIG. 2.

During the first movement of the luminous unit 10, the optical projection element 20 remains fixed. To be specific, by virtue of the front A, D and rear C, D pivot connections, only the rear portions 413, 423 and the central portions 411, 421 are moved, by pivoting about the front A, D and rear C, B pivot connections, as shown by the arrows S2. There is therefore a relative movement between the luminous unit 10 and the optical projection element 20, such that the light beam F1 is moved horizontally.

Following the movement S1 of the primary actuator H1, the light beam F1 is then located in the black zone on the grid shown in FIG. 2, whereas it was previously, that is to say before the actuation of the primary actuator H1, at the center of the grid. The light beam F1 is thus moved in the transverse direction Y.

FIG. 2 shows the case in which the primary actuator H1 pushes on the luminous unit 10, it being understood that it may also pull on the luminous unit. In this case, the light beam F1 is shifted in the other direction, i.e. to the right in the grid shown in FIG. 2.

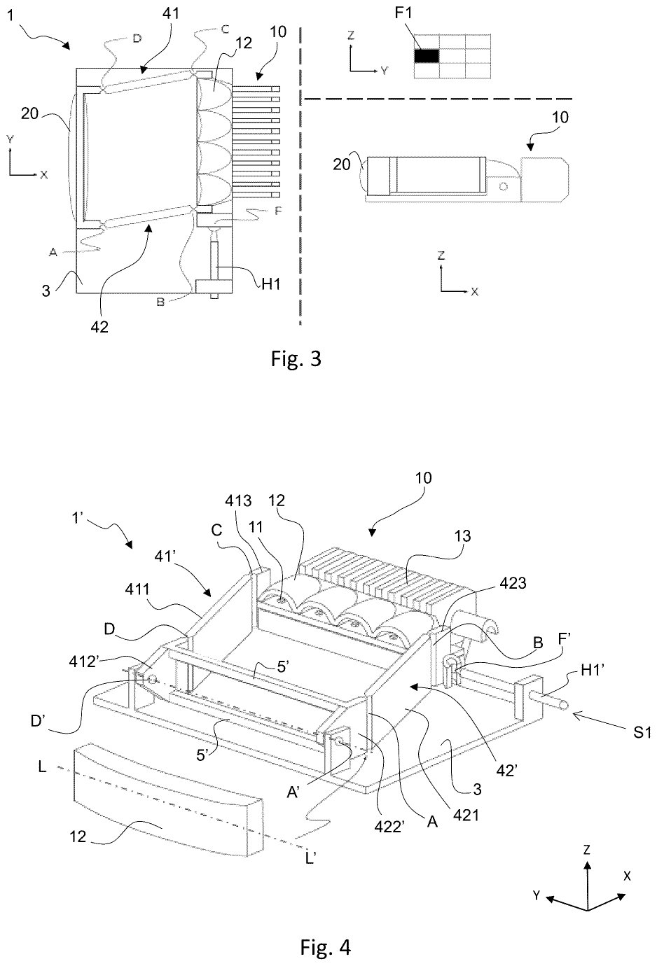

FIG. 3 shows, in top view and in side view, the position of the optical projection element 20, the connection elements 41, 42 and the luminous unit 10 when the movement S1 is exerted on the primary actuator H1. The translation in the transverse direction Y of the luminous unit 10 can thus be seen.

Note that in the first embodiment described with reference to FIGS. 1 to 3, the first light beam F1 may be moved only in the first orthogonal direction, and cannot be moved in a second orthogonal direction, such as the vertical direction Z. To be specific, since the front portions 412, 422 are fixedly mounted on the support 3, the luminous unit 10 cannot be moved vertically relative to the support 3 and to the optical projection element 20.

FIGS. 4 to 11 show a luminous module 1 for an automotive vehicle, according to a second embodiment of the invention. Elements common to the first embodiment bear the same reference numerals as in the first embodiment, and the description of these elements provided with reference to the first embodiment applies mutatis mutandis to the second embodiment, unless stated otherwise. They will not be described a second time.

Unlike the first embodiment, in which the first light beam F1 may only be moved in the first orthogonal direction, in the second embodiment, the first light beam F1 may be moved both in a first direction orthogonal to the optical axis O, and in a second direction orthogonal to the optical axis O. In the example shown, the first direction orthogonal to the optical axis O is a transverse direction Y and the second direction Z orthogonal to the optical axis is a vertical direction Z. In a variant that has not been shown, the first orthogonal direction could be the vertical direction Z, and the second orthogonal direction could be the transverse direction Y.

In order to allow the first light beam F1 to be moved in the second orthogonal direction Z, the luminous module 1′ comprises connection elements 41′, 42′ which differ from the connection elements 41, 42 of the first embodiment. The connection elements 41′, 42′ are configured and articulated in such a way as to allow, in addition to the first movement described above with reference to the first embodiment, a second movement of the luminous unit 10 relative to the optical projection element 20.

In the second embodiment, the front portion 412′, 422′ of each connection element 41′, 42′ differs from that of the first embodiment. The central portions 411, 421 and the rear portions 413, 423 are identical to those of the first embodiment. The front portion 412′, 422′ of each connection element 41′, 42′ is connected to the support 3 by an additional articulation allowing the rotation of the luminous unit 10 and the connection elements 41′, 42′ about an axis of rotation located in front of the front pivot connections A, D and oriented in the first orthogonal direction Y. In particular, each front portion 412′, 422′ is articulated to the support 3 by a pivot connection D′, A′ with an axis parallel to the first orthogonal direction Y.

The luminous module 1′ comprises two crossbars 5′ extending between the front portions 412′, 422′ of each connection element 41′, 42′. These crossbars 5′ make it possible to stiffen the connection elements 41′, 42′.

The optical projection element 20 comprises a median transverse axis LL′ coinciding with the axis of rotation of the pivot connections A′, D′. Alternatively, the median transverse axis LL′ may be arranged at a distance of less than 30 mm, preferably less than 15 mm, and even more preferably less than 5 mm from the axis of rotation. Thus, during the second movement of the luminous unit 10, the distance between the light sources 11 and the median transverse axis LL′ of the optical projection element 20 remains constant, which limits the deformation of the light beam F1 formed.

The optical projection element 20 is shown in front of the support 3 for the sake of clarity in FIG. 4. The optical projection element 20 is arranged on the support 3, in front of the front pivot connections A, D. Unlike the first embodiment, the optical projection element 20 is not attached to the front portions 412′, 422′ of the connection elements 41′, 42′.

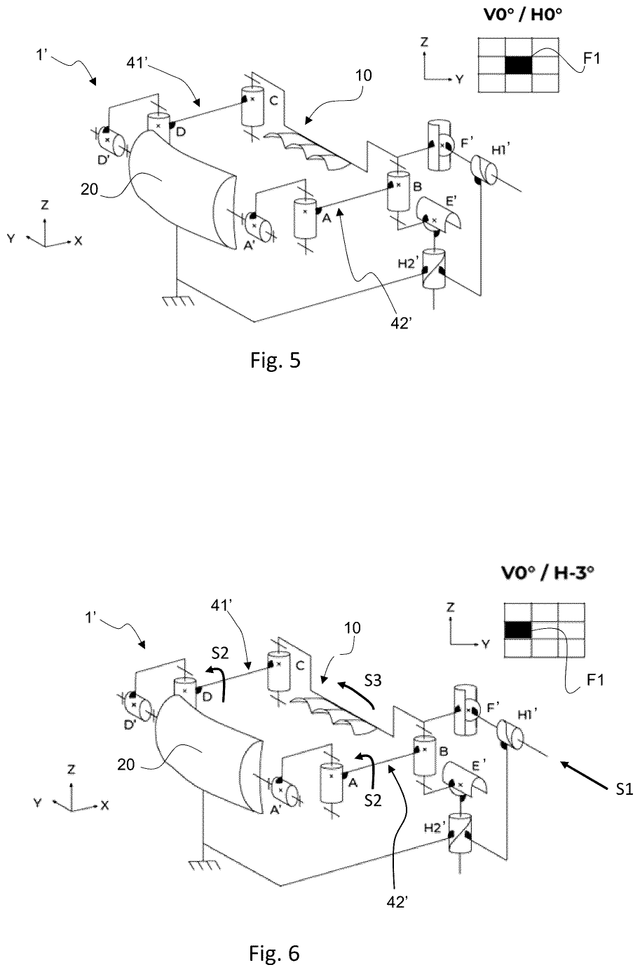

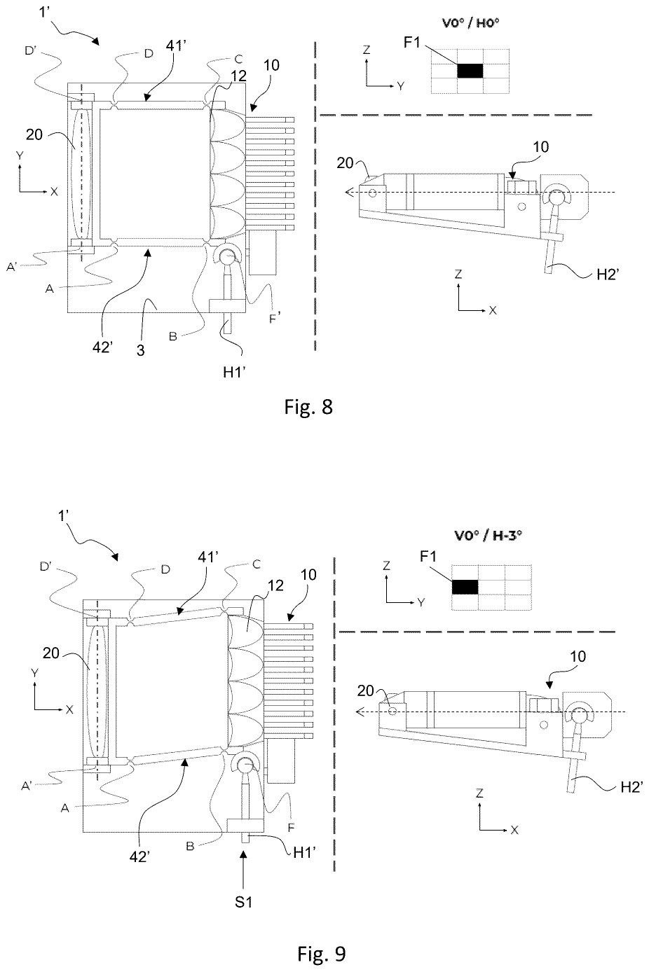

FIG. 5 shows a kinematic view of the luminous module 1′ when it is in a reference position or nominal position. The light beam F1 is then located in the center of the grid. FIG. 8 shows, in top view and in side view, the position of the optical projection element 20, the connection elements 41′, 42′ and the luminous unit 10 when the luminous module 1′ is in the reference position. The central portions 411, 421 extend parallel to the longitudinal direction X.

Note that in the example shown, the rear portions 412, 423 and the front portions 412′, 422′ also extend parallel to the longitudinal direction X in the nominal position.

The kinematics of the luminous module 1′ during the movement of the light beam F1 in the first orthogonal direction are shown in FIG. 6. As in the first embodiment, the first movement of the luminous unit 10 is activated by a primary actuator H1′, however, in this second embodiment, the luminous unit 10 is connected to the primary actuator H1′ by an annular linear connection F′ with an axis perpendicular to the first orthogonal direction Y and to the optical axis O. Thus, even when the luminous unit 10 is moved according to the second movement, in other words in the vertical direction Z, the primary actuator H1′ can still allow the luminous unit 10 to be moved according to the first movement.

FIG. 9 shows, in top view and in side view, the position of the optical projection element 20, the connection elements 41, 42 and the luminous unit 10 when the movement S1 is exerted on the primary actuator H1′. The translation in the transverse direction Y of the luminous unit 10 can thus be seen. The light beam F1 is moved from the center of the grid shown in FIGS. 5 and 8, to the black zone on the grid shown in FIGS. 6 and 9.

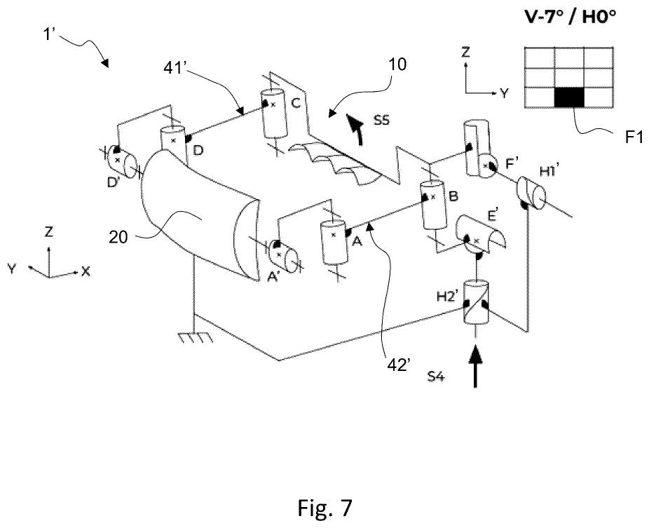

The kinematics of the luminous module 1′ during the movement of the light beam F1 in the second orthogonal direction are shown in FIG. 7. The second movement of the luminous unit 10 is activated by a secondary actuator H2′. The luminous unit 10 is connected to the secondary actuator H2′ by an annular linear connection E′ with an axis parallel to the first orthogonal direction Y. Thus, even when the luminous unit 10 is moved according to the first movement, the secondary actuator H2′ can still allow the luminous unit 10 to be moved according to the second movement.

In FIG. 7, a movement S4 is exerted on the secondary actuator H2′, the secondary actuator H2′ pushes the luminous unit 10, in particular the heat sink 13 on which the collectors and the light sources 11 are arranged. The luminous unit 10 follows the movement induced by the secondary actuator H2′ and is moved in a The luminous unit 10 follows the movement induced by the force S4 and is moved in a rotation about the axis of rotation formed by the pivot connections A′, D′. This movement is indicated by the arrow S5 in FIG. 7.

During the second movement of the luminous unit 10, the optical element 20 remains fixed relative to the support 3. Only the connection elements 41′, 42′ and the luminous unit 10 pivot about the pivot connections A′, D′ formed between the front portions 412′, 422′ and the support 3, and are therefore moved relative to the support 3. There is therefore a relative movement between the luminous unit 10 and the optical projection element 20, such that the light beam F1 is moved vertically.

Following the movement S4 of the secondary actuator H2′, the light beam F1 is then located in the black zone on the grid shown in FIG. 7, whereas it was previously, that is to say before the actuation of the secondary actuator H2′, at the center of the grid as shown in FIG. 5. The light beam F1 is thus moved in the vertical direction Z.

FIG. 7 shows the case in which the secondary actuator H2′ pushes on the luminous unit 10, it being understood that it may also pull on the luminous unit 10. In this case, the light beam F1 is shifted in the other direction, i.e. upward in the grid shown in FIG. 7.

FIG. 10 shows, in top view and in side view, the position of the optical projection element 20, the connection elements 41, 42 and the luminous unit 10 when the movement S4 is exerted on the secondary actuator H2′. The rotation of the luminous unit 10 about the axis of rotation formed by the pivot connections A′, D′ can thus be seen.

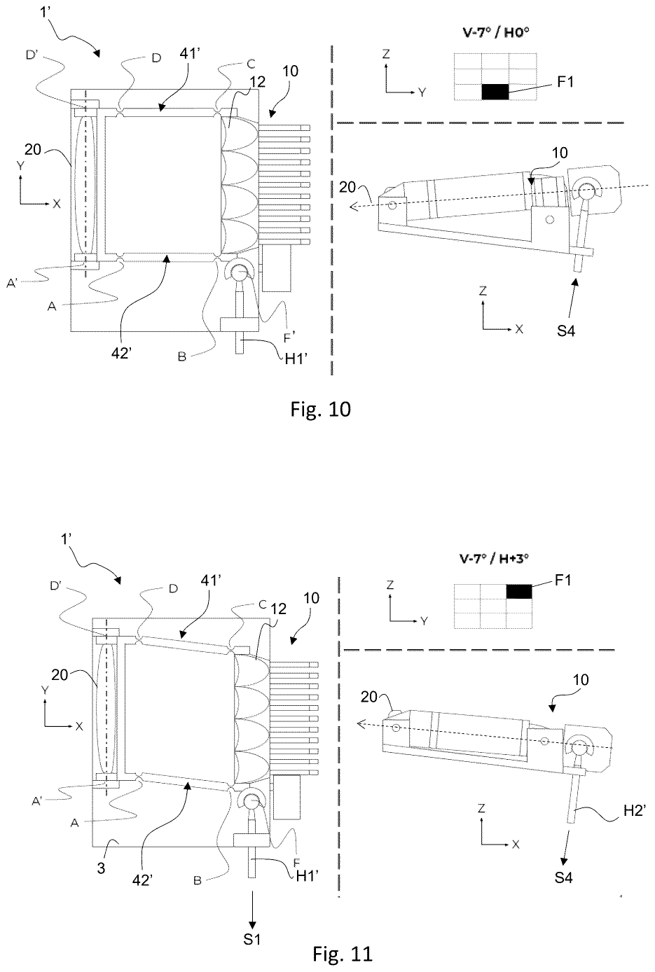

FIG. 11 shows, in top view and in side view, the position of the optical projection element 20, the connection elements 41, 42 and the luminous unit 10 when the luminous unit 10 is moved both according to the first movement by means of the primary actuator H1′ and according to the second movement by means of the secondary actuator H2′. The luminous unit 10 is then translated in the transverse direction Y and pivoted about the axis of rotation formed by the pivot connections A′, D′. In this example, the movement S1 of the primary actuator H1′ pulls on the luminous unit 10, and the movement S4 of the secondary actuator H2′ also pulls on the luminous unit 10. The light beam F1 is moved to the right and upward in the grid, relative to the reference position shown in FIGS. 5 and 8.

FIG. 12 depicts a variant embodiment of the luminous module 1′ according to the second embodiment. According to this variant, the luminous module 1′ comprises an additional connection element 43′ arranged between the two connection elements 41′, 42′, referred to as lateral connection elements. All of the other elements of the luminous module 1′ according to this variant are identical to those described with reference to FIGS. 4 to 11. Without departing from the scope of the invention, the luminous module 1′ could include several additional connection elements.

The additional connection element 43′ is arranged in the first orthogonal direction Y between two collectors 12. The additional connection element 43′ extends longitudinally between the luminous unit 10 and the optical projection element 20, and is configured and articulated in such a way as to allow the first and second movement of the luminous unit 10 relative to the optical projection element 20. The additional connection element 43′ then forms a separator within the luminous module 1′.

In particular, the additional connection element 43′ defines with the lateral connection elements 41′, 42′ optical cavities 7, 8 within the luminous module 1′, an optical cavity 7, 8 being delimited by two successive connection elements 41′, 42′, 43′. Each optical cavity 7, 8 comprises in particular the collector(s) 12 arranged between the two successive connection elements 41′, 42′, 43′ in question, and the light source(s) 11 associated with each of the collectors 12.

The additional connection element 43′ then prevents stray rays between the optical cavities 7, 8 of the luminous module 1′. In particular, the additional connection element 43′ prevents the light rays emitted by the light source(s) 11 of one optical cavity 7, 8 from reaching another optical cavity 7, 8.

In this case, each optical cavity 7, 8 may comprise a projection lens 27, 28 of its own. In particular, the optical projection element 20 may be formed by the juxtaposition of the projection lenses 27, 28 of each optical cavity 7, 8.

The additional connection element 43′ comprises a central portion 431′, a front portion 432′ and a rear portion 433′, the central portion 431′ and the rear portion 433′ being articulated by a rear pivot connection J with an axis orthogonal to the optical axis O and to the first orthogonal direction Y, and the central portion 431′ and the front portion 432′ being articulated by a front pivot connection I with an axis orthogonal to the optical axis O and to the first orthogonal direction Y.

The front I and rear J pivot connections are flexible connections with semicircular necks. The front 432′, central 431′ and rear 433′ portions of the additional connection element may then be formed integrally. The production of the connection elements in a single piece makes it possible to simplify the assembly of the luminous module and reduce its overall bulk. According to one alternative, the central portion 431′ may comprise at least a front cylindrical pin and a rear cylindrical pin with an axis orthogonal to the optical axis and to the first orthogonal direction, and the front portion 432′ may comprise a hole in which the front cylindrical pin is engaged in such a way as to form the front pivot connection I, and the rear portion 433′ may comprise a hole in which the rear cylindrical pin is engaged in such a way as to form the rear pivot connection J. In particular, the rear portion 433′ of the additional connection element 43′ may be formed by a part of the luminous unit 10, such as for example the collector. The production of the connection elements in three separate parts makes it possible to facilitate manufacture of the connection elements.

The front I and rear J pivot connections of the additional connection element 43′ define with the front A, D and rear C, D pivot connections of each of said lateral connection elements 41′, 42′, the vertices of a parallelogram, in projection in a plane defined by the optical axis O and the first orthogonal direction Y. Thus, the additional connection element 43′ may follow the deformation of said lateral connection elements 41′, 42′ during the first movement of the luminous unit 10.

The rear portion 433′ of the additional connection element 43′ is attached to the luminous unit 10. The front portion 432′ of the additional connection element may be connected to the front portions 412′, 422′ of the lateral connection elements 41′, 42′, for example via the crossbar 5′. Thus, the additional connection element 43 may follow the deformation of said lateral connection elements 41, 42 during the second movement of the luminous unit 10.

The additional connection element 43′ described with reference to the second embodiment may also be present in the luminous module 1 according to the first embodiment. The only difference will be the front portion 432′ of the additional connection element, which will be either connected to the front portions 412, 422 of the lateral connection elements 41′, 42′, for example via the crossbar 5, or fixedly mounted on the support 3.

FIGS. 14 and 15 depict another variant of the luminous module 1′ according to the second embodiment. In this variant, the front pivot connections A, D are formed by a cylindrical pin arranged on the central portion 411, 421 and a hole arranged on the front portion 412′, 422′, interacting with the cylindrical pin on the central portion 411, 421. The rear pivot connections B, C are formed by a cylindrical pin arranged on the central portion 411, 421 and a hole arranged on the rear portion 413, 423, interacting with the cylindrical pin on the central portion 411, 421. The cylindrical pins extend in the vertical direction Z. Alternatively, the holes could be located on the central portion 411, 421 and the cylindrical pins could be located on the front portions 412′, 422′ and the rear portions 413, 423 without departing from the scope of the invention.

When the primary actuator H1′ is activated, the cylindrical pins and the holes pivot relative to one another, in such a way as to allow the first movement of the luminous unit 10 relative to the support 3 and the optical projection element 20.

In this example, note that the collectors 12 form part of a cover part 121 extending the collectors 12 toward the front and toward the rear of the luminous module 1′. This cover part 121 forms part of the luminous unit 10. The rear portions 413, 423 of the connection elements 41′, 42′ are formed by the cover part 121.

In FIG. 15, the cover part 121, the support 3 and the optical projection element 20 have been removed. The two additional connection elements 43′ of the luminous module 1′ shown can thus be seen more clearly. In this variant, the luminous module 1′ thus comprises three optical cavities 7, 8, 9, each associated with a projection lens 27, 28, 29. The optical projection element 20 is formed by the juxtaposition of each of these projection lenses 27, 28, 29.

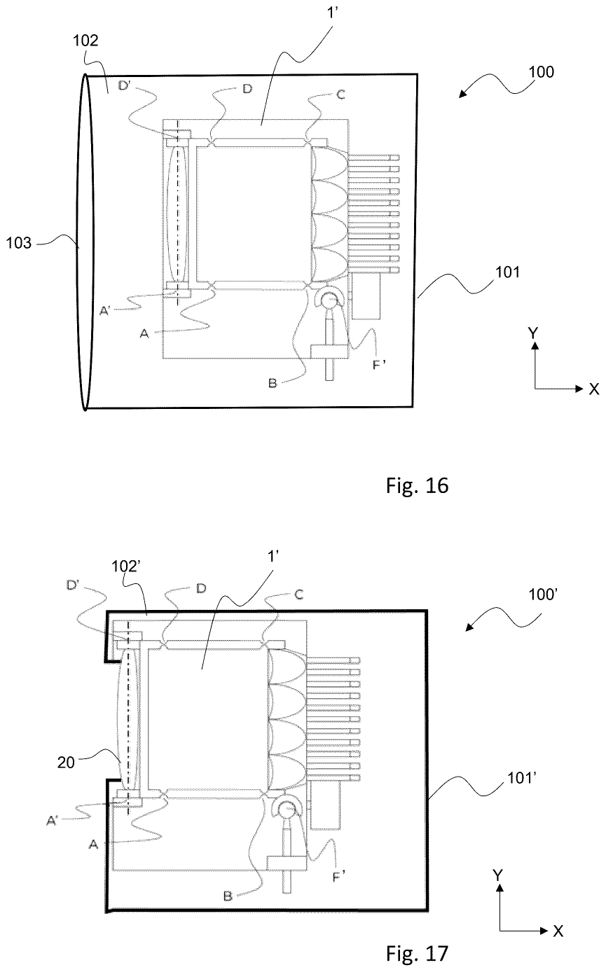

FIGS. 16 and 17 each show an alternative of a luminous device in which the luminous module according to the invention may be integrated. The luminous device may be a front headlamp of an automotive vehicle.

In FIG. 16, the luminous device 100 comprises a housing 101 having a recess 102 forming a casing, and an opening. The luminous device 100 also comprises a closure outer lens 103 closing off the opening. The luminous module 1′ according to the second embodiment of the invention is arranged in the casing, and is thus located between the walls forming the housing 101 and the closure outer lens 103. It will be appreciated that the luminous module 1 could be arranged in the casing without departing from the scope of the invention. The support 3 of the luminous module 1, 1′ is formed by a portion of the housing 101 or a part rigidly secured to the housing 101.

In FIG. 17, the luminous device 100′ comprises a housing 101′ having a recess 102′ forming a casing, and an opening. The luminous module 1′ according to the second embodiment of the invention is arranged in the casing. It will be appreciated that the luminous module 1 could be arranged in the casing without departing from the scope of the invention. The optical projection element 20 of the luminous module 1′, formed by a projection lens or a juxtaposition of projection lenses, closes off the opening of the housing 101. The luminous device 100′ then does not include any closure outer lens, which allows an increase of approximately 15% in terms of efficiency for the luminous device 100. The optical projection element 20 plays the role of the closure outer lens. To be specific, since the optical projection element 20 remains fixed when the light beam F1 is moved according to the first movement or according to the first movement and the second movement, the optical projection element 20 can close off the opening of the housing 101.

What is claimed is:

1. A luminous module for an automotive vehicle, the luminous module comprising:
a luminous unit including:
at least one light source configured to emit light rays,
at least one collector associated with the at least one light source,
an optical projection element having an optical axis, the collector being configured to collect and direct the light rays emitted by the at least one light source toward the optical projection element, the optical projection element being configured to project the light rays toward the outside of the vehicle to form a light beam,
support on which the optical projection element is fixedly mounted;
two connection elements each connected on the one hand to the luminous unit and on the other hand to the support, each connection element being configured and articulated in such a way as to allow a first movement of the luminous unit relative to the optical projection element, the first movement allowing the light beam to be moved in a first direction orthogonal to the optical axis of the optical projection element.

2. The luminous module as claimed in claim 1, wherein each connection element includes a central portion, a front portion and a rear portion, the central portion and the rear portion being articulated by a rear pivot connection with an axis orthogonal to the optical axis and to the first orthogonal direction, and the central portion and the front portion being articulated by a front pivot connection with an axis orthogonal to the optical axis and to the first orthogonal direction.

3. The luminous module as claimed in claim 2, wherein the optical projection element is arranged in front of the front pivot connections and the luminous unit is attached to the rear portions.

4. The luminous module as claimed in claim 2, wherein the front and rear pivot connections define the vertices of a parallelogram, in projection in a plane defined by the optical axis and the first orthogonal direction.

5. The luminous module as claimed in claim 1, wherein the first movement of the luminous unit is intended to be activated by a primary actuator, the luminous unit being configured to be connected to the primary actuator by an annular linear connection with an axis perpendicular to the first orthogonal direction and to the optical axis.

6. The luminous module as claimed in claim 1, wherein each connection element is configured and articulated in such a way as to allow a second movement of the luminous unit relative to the optical projection element, the second movement allowing the light beam to be moved in a second direction orthogonal to the optical axis of the optical projection element, and orthogonal to the first orthogonal direction.

7. The luminous module as claimed in claim 6, wherein the front portion of each connection element is connected to the support by an additional articulation allowing the rotation of the luminous unit and the connection elements about an axis of rotation located in front of a front pivot connections and oriented in the first orthogonal direction.

8. The luminous module as claimed in claim 7, wherein the optical projection element includes a median transverse axis coinciding with the axis of rotation.

9. The luminous module as claimed in claim 6, wherein the second movement of the luminous unit is intended to be activated by a secondary actuator, the luminous unit being configured to be connected to the secondary actuator by an annular linear connection with an axis parallel to the first orthogonal direction.

10. The luminous module as claimed in claim 1, wherein the luminous unit includes at least two collectors, at least one light source associated with each collector, and at least one additional connection element arranged between the two collectors and between the two connection elements, referred to as lateral connection elements, in the first orthogonal direction, the additional connection element extending longitudinally between the luminous unit and the optical projection element, and being configured and articulated in such a way as to allow the first movement of the luminous unit relative to the optical projection element, or the first and second movement of the luminous unit relative to the optical projection element.

11. A luminous device for an automotive vehicle, comprising a housing having a recess and a luminous module, the luminous module being arranged in the recess and includes a luminous unit including at least one light source configured to emit light rays, at least one collector associated with the at least one light source, an optical projection element having an optical axis, the collector being configured to collect and direct the light rays emitted by the at least one light source toward the optical projection element, the optical projection element being configured to project the light rays toward the outside of the vehicle to form a light beam, a support on which the optical projection element is fixedly mounted, and two connection elements each connected on the one hand to the luminous unit and on the other hand to the support, each connection element being configured and articulated in such a way as to allow a first movement of the luminous unit relative to the optical projection element, the first movement allowing the light beam to be moved in a first direction orthogonal to the optical axis of the optical projection element.

12. The luminous device as claimed in claim 11, wherein the support of the luminous module is formed by a portion of the housing or a part rigidly secured to the housing.

13. The luminous device as claimed in claim 11, wherein the housing includes an opening arranged in front of the recess, the optical projection element closing off the opening of the housing.
